(19) United States
(12) Patent Application Publication
(10) Pub. No.: US 2016/0135586 A1
(43) Pub. Date: May 19, 2016

(54) FURNITURE STAND WITH REVERSIBLE CONFIGURATION

(71) Applicant: Ameriwood Industries, Inc., Wright City, MO (US)

(72) Inventors: Cory Neudeck, Wentzville, MO (US); William Noble, Des Peres, MO (US)

(21) Appl. No.: 14/938,594

(22) Filed: Nov. 11, 2015

Related U.S. Application Data
(63) Continuation-in-part of application No. 14/859,879, filed on Sep. 21, 2015.
(60) Provisional application No. 62/052,925, filed on Sep. 19, 2014.

(51) Int. Cl. A47B 13/08; A47B 81/00; A47B 13/00; A47F 3/00; A01K 63/00; A47B 83/04

(52) U.S. Cl. CPC A47B 13/08; A01K 63/006; A47B 83/045; A47B 13/003; A47F 3/005; A47B 81/00

(57) ABSTRACT

Pieces of furniture which have a single configuration of parts, but that configuration allows for two different positions into which they may be placed and those positions provide different functionality from each other. Thus, the furniture has two different uses, but switching between them simply requires placing the piece of furniture in a different arrangement instead of removing or adding parts or moving parts relative to each other. Specifically, the piece of furniture is generally “flipped-over” to switch between arrangements.

### CROSS REFERENCE TO RELATED APPLICATIONS)

This application is a Continuation-In-Part (CIP) of U.S. Utility patent application Ser. No. 14/859,879, filed Sep. 21, 2015, which in turn claims the benefit of U.S. Provisional Patent Application Ser. No. 62/052,925, filed Sep. 19, 2014. The entire disclosure of both the above documents is herein incorporated by reference.

### BACKGROUND OF THE INVENTION

1. Field of the Invention

The invention relates generally to furniture which, once assembled, can be positioned in more than one position to allow it to have different purposes. In particular, the piece of furniture is designed to support multiple different sizes of objects without modification to its structure when switching between positions and objects it supports.

2. Description of the Related Art

Furniture generally is designed to have a single configuration or placement once it has been assembled and is customized for its purpose with that configuration and placement in mind. For example, most bookshelves are designed to stand upright with an obvious top and bottom and they would not function and/or would have an undesirable appearance if positioned in an alternative position. For example, a bookshelf placed on its side is generally unable to support books in a reasonable fashion, and, if placed upside down, is generally not stable or attractive as it will often have small legs or feet which may now be sticking up.

There are some pieces of furniture which are essentially blocks having no real upside-down or right-side-up configuration to provide for ease of use. For example, a bookshelf may not have an obvious top or bottom as both end pieces may be simple boards of identical shape and size. While these provide for some flexibility in installation, these pieces of furniture do not truly provide for an alternative position. Instead, they actually only provide a single option for positioning, but allow for multiple ways of obtaining it. In effect, there is no difference between the positions in which this kind of furniture can be placed, e.g., the bookshelf may be identical if it is right-side-up or upside-down.

A piece of furniture with multiple purposes can be particularly valuable. For a consumer, it can allow them to adapt the furniture to a changing lifestyle and for a retailer, it can allow them to increase the types of furniture they have available for sale without need to take up additional valuable display or storage space. For example, if a single piece of furniture can function as two different pieces in different configurations, it allows the retailer to stock only a single piece of inventory to fill two needs and for a consumer to purchase a single piece regardless of whether the consumer needs either, or both, of the alternatives.

There are, for example, certain types of furniture which provide for different purposes by allowing for the addition or removal of certain components to switch between configurations. For example, baby cribs can often be modified into toddler beds through the removal of one or more of the sides of the crib and the replacement of that side with a shorter part-wall that still supports the remaining crib walls but allows a toddler to safely climb in and out. While this type of modification is common, it is less than ideal for a number of reasons. Firstly, it generally requires the end consumer to at least partially disassemble the piece of furniture (which can often require them to locate specialized tools for assembly that came with the furniture) and it requires the consumer to store the parts of the unused configuration somewhere when the consumer is not using these parts. As these parts are often heavy and bulky, this can present its own challenges.

### SUMMARY OF THE INVENTION

The following is a summary of the invention, which should provide to the reader a basic understanding of some aspects of the invention. This summary is not intended to identify critical elements of the invention or in any way to delineate the scope of the invention. The sole purpose of this summary is to present in simplified text some aspects of the invention as a prelude to the more detailed description presented below.

There are described herein, pieces of furniture which have what is termed a “reversible configuration.” The piece of furniture has a single configuration of parts, but that configuration allows for two different positions into which it may be placed and those positions provide different functionality from each other. Thus, the furniture has two different uses, but switching between the uses simply requires placing the piece of furniture in a different arrangement instead of removing or adding parts or moving parts relative to each other. Specifically, the piece of furniture is generally “flipped-over” to switch between arrangements.

There is described herein, in an embodiment, a piece of furniture comprising: a central body structure having side panels and a volume at least partially enclosed by said side panels; a generally planar first table having a first size attached via a major surface to said side panels at a first end of said side panels; and a generally planar second table having a second size attached via a major surface to said side panels at a second end of said side panels, said second end being at a position opposing said first end so that said central body structure interconnects said first table and said second table; wherein said first size and said second size are different; and wherein said piece of furniture is configured to rest on either said first table or said second table, but not on both simultaneously.

In an embodiment of the piece of furniture, the first size and said second size are each an area of a major surface of said first table and said second table.

In an embodiment of the piece of furniture, the first size and said second size are each a shape of said first table and said second table.

In an embodiment of the piece of furniture, the first table and said second table have identical surface area of a major surface.

In an embodiment of the piece of furniture, the first size and said second size are each specific dimensions said first table and said second table.

In an embodiment of the piece of furniture, the first table and said second table have identical surface area of a major surface.

In an embodiment of the piece of furniture, the volume is not completely enclosed by said side panels, said first table, and said second table.

In an embodiment of the piece of furniture, the volume is completely enclosed by said side panels, said first table, and said second table.

In an embodiment, the piece of furniture further comprises a rear panel at least partially enclosing said volume.

In an embodiment of the piece of furniture, the volume is not completely enclosed by said side panels, said rear panel, said first table, and said second table.

In an embodiment of the piece of furniture, the volume is completely enclosed by said side panels, said rear panel, said first table, and said second table.

In an embodiment, the piece of furniture further comprises a shelf located within said volume.

In an embodiment, the piece of furniture further comprises a cabinet located within said volume.

In an embodiment of the piece of furniture, the side panels are all interchangeable.

In an embodiment of the piece of furniture, the piece of furniture is an aquarium stand.

In an embodiment of the piece of furniture, the first table is configured to support a ten-gallon aquarium and said second table is configured to support a twenty-gallon aquarium.

### BRIEF DESCRIPTION OF THE DRAWINGS

FIG. 1 provides a perspective view of a first embodiment of a piece of furniture with a reversible configuration.

FIG. 2 provides a front view of a first embodiment of a piece of furniture with a reversible configuration.

FIG. 3 provides a side view of a first embodiment of a piece of furniture with a reversible configuration.

FIG. 4 provides a top view of a first embodiment of a piece of furniture with a reversible configuration.

FIG. 5 shows the piece of furniture of FIGS. 1-4 as it could be used in a first arrangement for supporting a 10-gallon aquarium.

FIG. 6 shows the piece of furniture of FIGS. 1-4 as it could be used in a second arrangement for supporting a 20-gallon aquarium.

FIG. 7 shows a front view of a second embodiment of a piece of furniture with a reversible configuration.

### DETAILED DESCRIPTION OF THE PREFERRED EMBODIMENT(S)

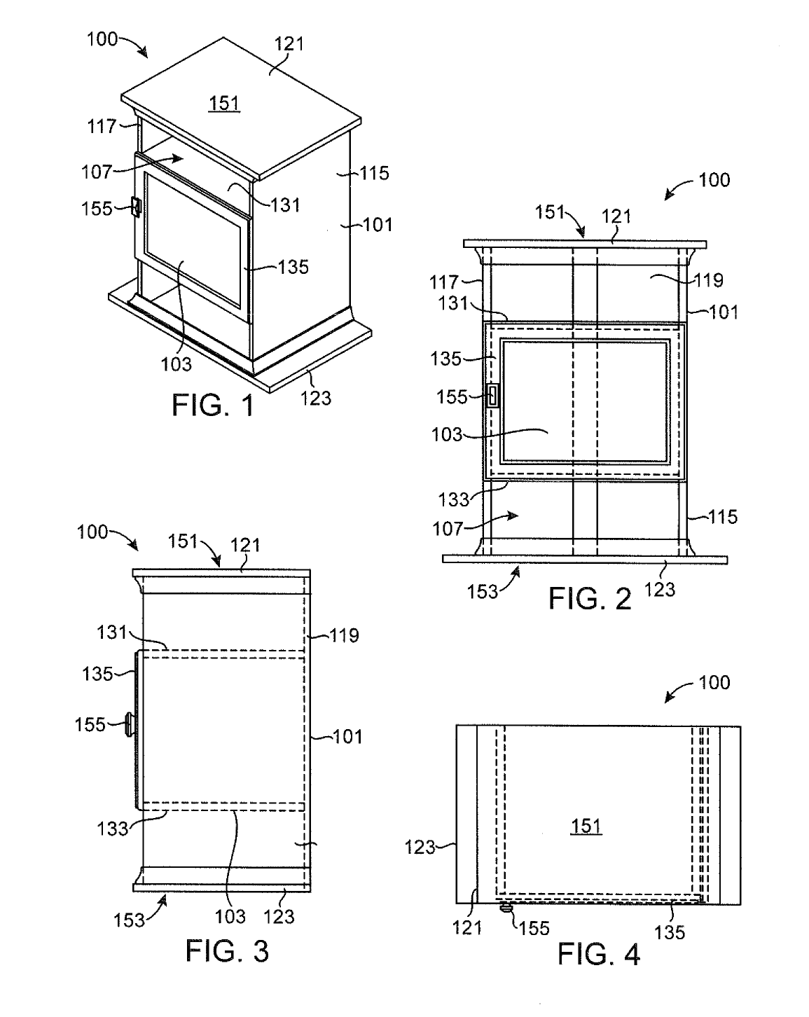

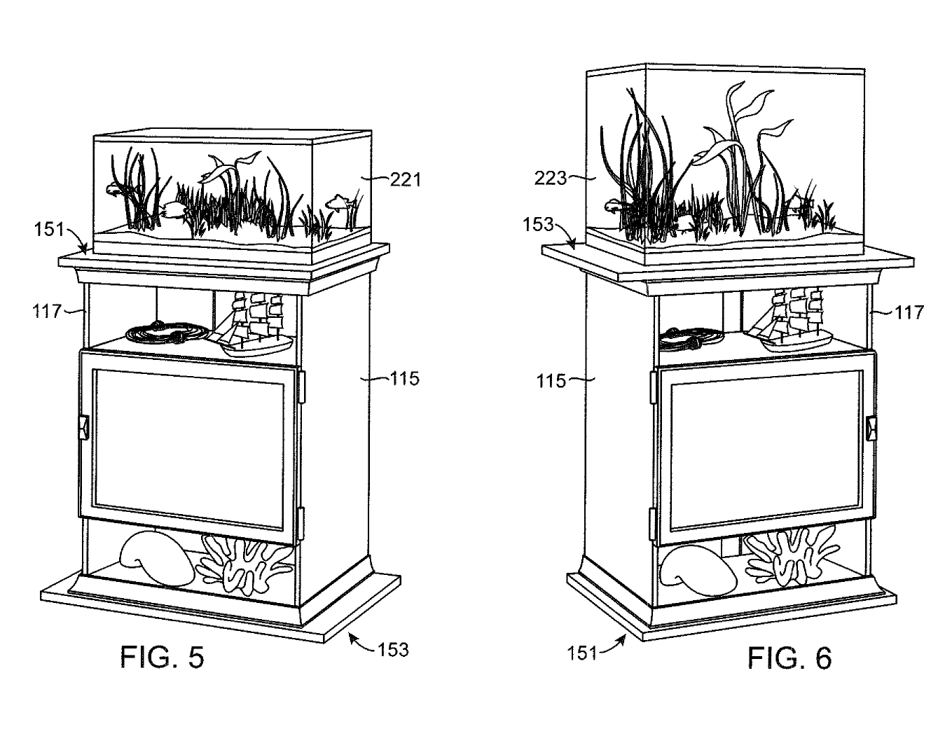

FIGS. 1-4 provide a first embodiment of a piece of furniture (100) with a reversible configuration. The piece of furniture (100) in this embodiment is designed to be an aquarium stand and can be “flipped” so that it can support two different sizes of an aquarium, specifically a 10-gallon aquarium (221) and a 20-gallon aquarium (223) as shown respectively in FIGS. 5 and 6.

The embodiment of the piece of furniture (100) shown in FIGS. 1-4 will generally comprise a central body structure (101) which will usually provide for a vertical extension and provide the height of the furniture piece (100). In the depicted embodiment, the central body structure (101) comprises two generally planar side walls (115) and (117), and a generally planar rear wall (119). The central body structure (101) is capped by two tables (121) and (123) with one of the tables (121) and (123) arranged on each end of the central body structure (101). This gives the central body structure (101) a conventional hollow parallelepiped shape which is open on one side, thus providing an accessible volume (107).

The shape of the central body structure (101) shown in FIGS. 1-4 is by no means required and, in alternative shapes, the structure can, for example, be cylindrical vertically (open in a portion of the side with the tables arranged on opposing ends). In this arrangement, the two side walls (115) and (117) and the rear wall (119) would essentially comprise one contiguous curve. However, the description of the walls as “side” and “rear” is still relevant to indicate the relative positioning of other components.

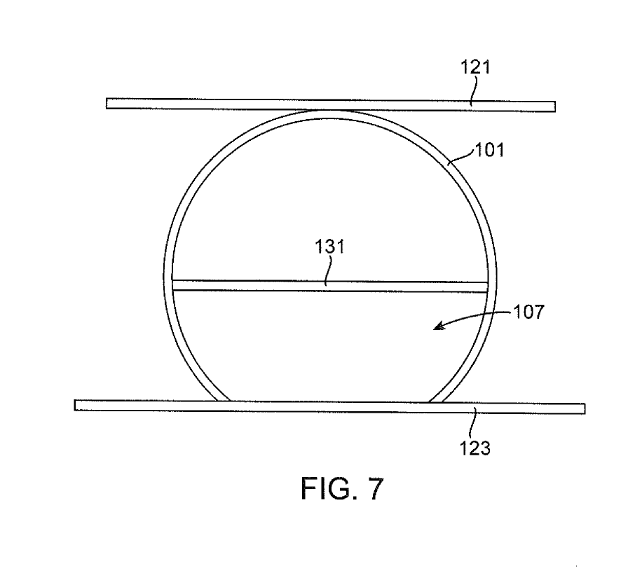

In the embodiment of FIG. 7, the central body structure (101) comprises a part cylinder arranged horizontally. Thus, it is open on a cylinder end (facing the user in FIG. 7) and may be closed with a rear wall (119) or that may remain open as shown in FIG. 7. In the embodiment of FIG. 7, the tables (121) and (123) are arranged on opposing tangents or chords. Thus, in this arrangement, the table (123) closes off one end of the volume (117), but the other table (221) is outside the central body structure (101) and does not contact the volume (107).

It should be apparent to one of ordinary skill in the art that, while FIGS. 1-4 and 7 provide for a couple of different embodiments, these are, in no way, the only shapes that the central body structure (101) may assume, and the central body structure can have a virtually limitless number of shapes in different embodiments. The key element is that the central body structure (101) has the two tables (121) and (123) positioned in opposing positions on the central body structure (101). To put this another way, the two tables (121) and (123) are arranged at 180 degrees from each other relative to the central point of the center body structure (101) or are arranged on opposing “sides” (namely, the top and bottom ends) of the central body structure (101).

In an embodiment of the piece of furniture (101), no further structure other than at least the side walls (115) and (117) (and these may be co-formed such as in the horizontal cylinder scenario above) need be present to form a central body structure (101). However, the structure shown in FIGS. 1-4 provides for better use of space and a piece of furniture that provides for additional functionality related to its support capability.

In the embodiment of FIGS. 1-4, the central body structure (101) includes two shelves (131) and (133) which are positioned within the partially enclosed volume (107) of the central body structure (101). There is then a door (135) which is positioned in front of the position of the volume (107) between the two shelves (131) and (133). The door (135) is hinged to the wall (115) and has a handle (155) on the opposing side.

As can be seen in the embodiment of FIGS. 1 through 4, the combination of the two shelves (131) and (133), the two side walls (115) and (117), and the door (135) forms a central cabinet (103). A cabinet (103) or cabinet-like structure is not required, and alternatively any number of shelves (131) (133), doors (135), or other structures known to those of ordinary skill in the art of furniture construction (including no such structures), may be positioned in the volume of the central body structure (101). In the embodiment of FIG. 7, a single shelf (131) is provided. Further, a door (135) could be hinged to a different component such as wall (117) or either of the shelves (131) and (133).

As is best seen in FIGS. 2 and 3, the depicted central body structure (101) is preferably in the form of a vertically mirrored image. Specifically, the lower half of the depicted central body structure is essentially a mirror image of the top about the midpoint. With this arrangement, as can be seen in FIGS. 5 and 6, the central body structure (101) will look generally the same regardless of whether the furniture (100) is in the arrangement of FIG. 5 or 6. While it is generally preferred that the central body structure (101) have this mirror image about its midpoint shape as it provides for a consistent storage area regardless of arrangement between FIGS. 5 and 6, it is not required. However, this does provide the same number of shelves (131) and (133) and cabinets (103) in the same relative position and spacing of shelves (131) and (133) and cabinets (103) regardless of orientation between FIGS. 5 and 6.

The tables (121) and (123), in the depicted embodiment, are generally rectangular and planar, but that is not required and the tables (121) and (123) may be of any generally planar shape including rectangles, squares, circles, or other polygons. Each table (121) and (123) will generally have a generally flat upper surface where the upper surface is defined as the surface comparing the two major surfaces of each of the tables (121) or (123) positioned furthest from the central body structure (101), as can be best seen in FIGS. 2 and 4. The two tables (121) and (123) must be of different size.

Generally, the different sizing of the tables (121) and (123) will be manifested by the tables (121) and (123) being the same generally shape but having different surface areas by extending one of the tables (121) or (123) in one dimension, as shown in the embodiment of FIGS. 1-4, but it may also be manifest by the tables (121) and (123) being different shapes a circle and a rectangle) whether having the same area or not, or by the table (121) and (123) being the same shape but having different relative dimensions (e.g., the tables are both rectangles, but one is 4×3 feet while the other is 6×2 feet), whether having the same area or not.

Having the two tables (121) and (123) be of different size provides for the piece of furniture to be used on two different arrangements, as shown in FIGS. 5 and 6. Specifically, the furniture, when positioned, is placed with the upper surface (as defined above) of one of the tables (121) or (123) in contact with the floor or other surface upon which the furniture rests. The other table's (121) or (123) upper surface is generally facing exactly the opposite direction and presents a generally planar surface upon which an object can be rested. In FIG. 5, the surface (153) is the one upon which the furniture (100) stands and the surface (151) is used for placement of the 10-gallon aquarium (221). In FIG. 6, the opposite is true and the surface (151) is the one upon which the furniture (100) rests and the surface (153) is used for placement of the 20-gallon aquarium (223).

In use, the furniture (100) will generally be purchased and assembled as necessary. The consumer or user will place it (arrange it) based on which surface (151) or (153) they want to use as the surface upon which to place objects. This selection will generally be dependent on the size of specific other objects as the piece of furniture contemplated herein is primarily designed to act as a stand or support for other objects. Selection is made by simply flipping the piece of furniture over to obtain a piece of furniture suitable for, and often specialized for, a different task.

In the depicted example of FIGS. 5. and 6, the different tasks are holding aquariums of different sizes. Specifically, FIG. 5 is used for supporting a 10-gallon aquarium (221) which generally has a smaller footprint, and FIG. 6 is used for supporting a 20-gallon aquarium (223) with a larger footprint. It should be apparent that placing the 20-gallon aquarium (223) on surface (151) will mean it overhangs the table (121) presenting a potentially unstable scenario. Further, placing the 10-gallon aquarium (221) on the surface (153) would provide for significant table (123) overhang outside the aquarium, which is subject to being impacted, causing damage or rendering the furniture (100) unsteady.

Aquariums are generally very heavy once filled with water, and one does not want to have an aquarium that is not well supported, as this can result in a hazard as well as a risk of loss of the aquarium. Stands for aquariums are often sized for a specific size of aquarium to provide good support as aquariums are generally of standard sizes and configurations. Having a table which is too large or too small can present a situation where the stand is more likely to be knocked over than having a stand correctly sized. The present piece of furniture can provide good support, and can be sized and shaped to support two different sizes of aquarium, such as those of standard 20 and 10 gallon parallelepiped configuration, as shown in FIGS. 5 and 6.

It should be apparent that the piece of furniture (100) is not intended to be modified between one arrangement to the other. Rather, it is simply turned over (with the original table (121) or (123) that was the top now being the base and vice versa). This is best illustrated by comparing FIG. 5 with FIG. 6. This simple difference of arrangement to provide what are, essentially, two different pieces of furniture for different purposes, is important as it allows the end consumer of the furniture to not need to modify the furniture between configurations and to allow the furniture to be provided without extra pieces that have to be stored while retaining is reversible configuration nature.

While the figures shown herein particularly focus on a piece of furniture (100) primarily for use as an aquarium stand for two differently sized aquariums which is designed to rotate 180 degrees to reach a different arrangement, this is by no means required. In an alternative embodiment of the invention, the stand can rotate 90 degrees (in any direction) or could rotate some other amount depending on its shape (e.g. if it was not a parallelepiped). Further, while the stand in the present figures is designed to have two configurations, an alternative embodiment of the invention could have 3 or more configurations depending on which surface was used as a base. For example, the furniture (100) could include three or more tables with the three or more tables arranged at equal rotations around the center body structure (101). However, in such an embodiment, the tables would still be differently sized from each other.

Still further, an alternative embodiment of the invention could be a piece of furniture that is not an aquarium stand. It may be instead, but is not limited to, a bookcase, a chair, a table, a television or media stand, a bureau, a dresser, a chest of drawers, a cabinet, a crib or bed, or a stand designed to support multiple different types of objects.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

1. A piece of furniture comprising:
a central body structure having side panels and a volume at least partially enclosed by said side panels;
a generally planar first table having a first size attached via a major surface to said side panels at a first end of said side panels; and
a generally planar second table having a second size attached via a major surface to said side panels at a second end of said side panels, said second end being at a position opposing said first end so that said central body structure interconnects said first table and said second table;
wherein said first size and said second size are different; and
wherein said piece of furniture is configured to rest on either said first table or said second table, but not on both simultaneously.

2. The piece of furniture of claim 1 wherein said first size and said second size are each an area of a major surface of said first table and said second table.

3. The piece of furniture of claim 1 wherein said first size and said second size are each a shape of said first table and said second table.

4. The piece of furniture of claim 3 wherein said first table and said second table have the identical surface area of a major surface.

5. The piece of furniture of claim 1 wherein said first size and said second size are each specific dimensions said first table and said second table.

6. The piece of furniture of claim 5 wherein said first table and said second table have the identical surface area of a major surface.

7. The piece of furniture of claim 1 wherein said volume is not completely enclosed by said side panels, said first table, and said second table.

8. The piece of furniture of claim 1 wherein said volume is completely enclosed by said side panels, said first table, and said second table.

9. The piece of furniture of claim 1 further comprising a rear panel at least partially enclosing said volume.

10. The piece of furniture of claim 9 wherein said volume is not completely enclosed by said side panels, said rear panel, said first table, and said second table.

11. The piece of furniture of claim 9 wherein said volume is completely enclosed by said side panels, said rear panel, said first table, and said second table.

12. The piece of furniture of claim 1 further comprising a shelf located within said volume.

13. The piece of furniture of claim 1 further comprising a cabinet located within said volume.

14. The piece of furniture of claim 1 wherein said side panels are all interchangeable.

15. The piece of furniture of claim 1 wherein said piece of furniture is an aquarium stand.

16. The piece of furniture of claim 15 wherein said first table is configured to support a ten-gallon aquarium and said second table is configured to support a twenty-gallon aquarium.
